(19) United States
(12) Patent Application Publication
(10) Pub. No.: US 2004/0257831 A1
(43) Pub. Date: Dec. 23, 2004

(54) Illuminating decoration for skateboard

(76) Inventor: Cheng Chou Liao, Taipei City (TW)

Correspondence Address: RABIN & BERDO, P.C., Suite 500, 1101 14th Street, N.W., Washington, DC, 20005, US

(21) Appl. No.: 10/600,754

(22) Filed: Jun. 23, 2003

(51) Int. Cl. B60Q 1/00; B60Q 1/064

(52) U.S. Cl. 362/565

(57) ABSTRACT

An illuminating decoration for skateboard includes two illuminating tubes attached to two lateral sides of a skateboard, and electrically connected to a control box provided at an underside of the skateboard, so that the two illuminating tubes are turned on or off through control of the control box. Each of the two illuminating tubes includes a transparent tube and a plurality of light-emitting elements disposed in the transparent tube. The illuminating tubes are sealed at front and rear ends thereof, such that the light-emitting elements are enclosed in the transparent tubes to emit light and produce even brightness without the risk of being invaded by dust and moisture. The transparent tube is flexible and therefore impact resistant.

### FIELD OF THE INVENTION

The present invention relates to an illuminating decoration for skateboard, and more particularly to an illuminating decoration that is mounted at two lateral sides of a skateboard to provide even brightness, and is impact-resistant, moisture-proof and dustproof.

### BACKGROUND OF THE INVENTION

Skateboarding has become one of many popular leisure activities among young people in recent years. There are various commercially available skateboards showing changeful styles for consumers' choice. Although the conventional skateboards are provided with various kinds of designs, patterns or shapes, they do not include any illuminating device. It is therefore dangerous to play the conventional skateboards in the nighttime. In an attempt to overcome this problem, there is developed a skateboard with illuminating device.

FIG. 1 is a bottom perspective view of a conventional skateboard 1 provided with an illuminating device. The illuminating device includes a light-conducting tube 11, along which a plurality of through holes 12 is drilled at intervals of a predetermined short distance. The light-conducting tube 11 is attached to a peripheral edge of the skateboard 1 by means of fixing screws 121 separately extended through the holes 12. A plurality of lamp bulbs 13 is located in the light-conducting tube 11. Metal plates 131 are attached to the light-conducting tube 11 to separately shield the lamp bulbs 13. A control box 14 is provided at an underside of the skateboard 1 for controlling on/off of the lamp bulbs 13. When the lamp bulbs 13 are turned on via the control box 14, light produced by the lamp bulbs 13 and radiated on areas surrounding the holes 12 is reflected and refracted at the holes 12 to form a plurality of light spots, which illuminate the peripheral edge of the skateboard 1. However, it is found on the skateboard 1 provided with the above-described illuminating device that holes 12 closer to the lamp bulbs 13 are brighter, while other holes 12 relatively distant from the lamp bulbs 13 are less bright or even completely dark due to insufficient light radiated thereto. That is, the whole light-conducting tube 11 shows uneven brightness at different areas.

Moreover, since the holes 12 are spaced at a short distance, light reflected and refracted at the holes 12 produces mutual interference to form halos. Another disadvantage of the above-described illuminating device for the skateboard 1 is the light-conducting tube 11 illuminated in this manner shows brightness that changes with different viewing angles. The light-conducting tube 11 might become dark when viewing from some angular portions relative to the skateboard 1.

Another problem with the conventional illuminating device for the skateboard 1 is the thorough holes 12 drilled on the light-conducting tube 11 admit moisture and dust in the open air into the light-conducting tube 11 to damage the latter.

In summary, the conventional illuminating device for the skateboard has the following disadvantages:

1. The use of the lamp bulbs 13 to radiate the holes 12 and produce light spots thereat would make holes 12 closer to the lamp bulbs 13 brighter and holes relatively distant from the lamp bulbs 13 darker. The whole light-conducting tube 11 shows uneven brightness.

2. The light-conducting tube 11 shows brightness that changes with different viewing angles, and might become completely dark when viewing from some angular portions.

3. The light-conducting tube 11 is subject to damage due to moisture and dust admitted into the tube 11 via the holes 12.

It is therefore tried by the inventor to develop an improved illuminating decoration for skateboard to overcome the drawbacks existed in the prior art.

### SUMMARY OF THE INVENTION

A primary object of the present invention is to provide an impact-resistant, moisture-proof and dustproof illuminating decoration for mounting at two lateral sides of a skateboard to provide even brightness.

To achieve the above and other objects, the illuminating decoration for skateboard of the present invention mainly includes two illuminating tubes attached to two lateral sides of a skateboard, and electrically connected to a control box provided at an underside of the skateboard, so that the two illuminating tubes are turned on or off through control of the control box. Each of the two illuminating tubes includes a transparent tube and a plurality of light-emitting elements disposed in the transparent tube. The illuminating tubes are sealed at front and rear ends thereof, such that the light-emitting elements are enclosed in the transparent tubes to emit light and produce even brightness without the risk of being invaded by dust and moisture. Moreover, the transparent tube is flexible and therefore impact resistant.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a bottom perspective view of a conventional skateboard provided with an illuminating device;

FIG. 2 is a fragmentary bottom exploded perspective view of an illuminating decoration for skateboard according to the present invention;

FIG. 3 is an assembled bottom perspective view of the illuminating decoration for skateboard according to the present invention; and

FIG. 3A is an enlarged view of the circled area of FIG. 3.

### DETAILED DESCRIPTION OF THE PREFERRED EMBODIMENTS

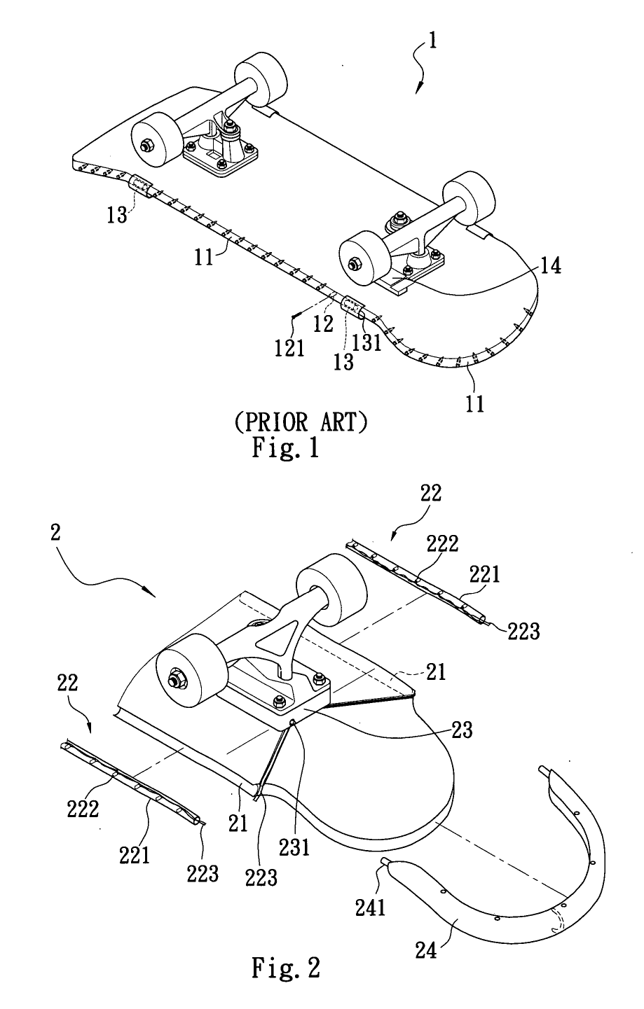

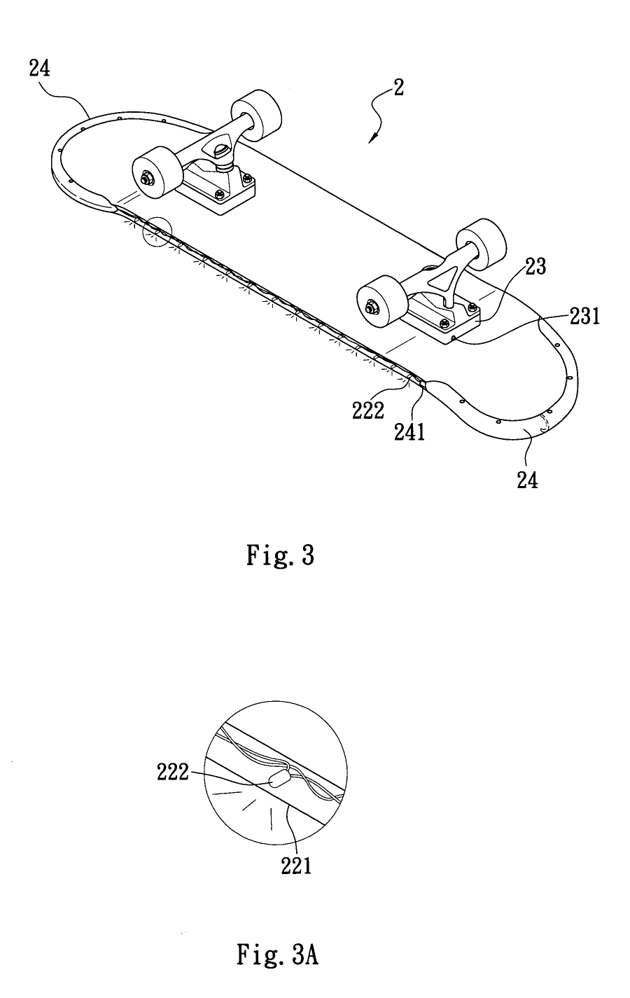

Please refer to FIGS. 2 and 3 that are exploded and assembled bottom perspective views, respectively, of an illuminating decoration for skateboard according to the present invention. As shown, a skateboard 2 is provided along a peripheral edge with a continuously extended recess 21. Two illuminating tubes 22 are fitted in portions of the recess 21 located at two lateral sides of the skateboard 2 by means of bonding agent. Each of the two illuminating tubes 22 includes a flexible transparent tube 221 and a plurality of light-emitting elements 222 disposed in the tube 221, as can be clearly seen from FIG. 3A. The light-emitting elements 222 are electrically connected to one another via conductors 223. An end of each conductor 223 is electrically connected to a control box 23 provided at an underside of the skateboard 2, so that the light-emitting elements 222 may be turned on or off via control of a push button 231 on the control box 23. Moreover, the control box 23 may be so designed that the push button 231 may be pushed by different times for the light-emitting elements 222 to produce light in the illuminating tube 22 in different manners.

A front and a rear hollow cover 24 having curved configurations corresponding to front and rear ends of the skateboard 2 are provided to fitly enclose and thereby locate in place at the front and rear ends of the skateboard 2. A rod 241 is forward projected from each free end of the curved front and rear covers 24 for fitly plugging into and thereby sealing the front and rear ends of the two illuminating tubes 22.

The above-mentioned conductors 223 extended from the illuminating tubes 22 are embedded in grooves pre-formed at the underside of the skateboard 2 to electrically connect to the control box 23. The grooves may be covered later to seal the underside of the skateboard 2.

Since the light-emitting elements 222 are sealed in the transparent tubes 221, they could produce light in the transparent tubes 221 without the risk of being invaded by dust and moisture. The illuminating tubes 22 can therefore have prolonged usable life.

With the above arrangements, the light-emitting elements 222 produce light spots that do not change in brightness due to different positions on the illuminating tubes 22 or different viewing angle relative to the illuminating tubes 22. That is, any user or any other viewer would see the same brightness of the illuminating tubes 22 no matter what viewing angular position of the user or the viewer is relative to the skateboard 2. The problem of uneven brightness at different locations on the illuminating tubes 22 is therefore eliminated. Moreover, the flexible illuminating tubes 22 maybe fitly attached to the recess 21 in compliance with the curved peripheral edge of the skateboard 2 and provides enhanced wear resistance.

In summary, the illuminating decoration for skateboard of the present invention has the following advantages:

1. Since each of the illuminating tubes 22 includes a transparent tube 221 having the light-emitting elements 222 disposed therein, light spots produced by the light-emitting elements 222 on the illuminating tubes 22 have uniform brightness that does not change due to different positions of the light spots on the illuminating tubes 22 or different viewing angles of viewers relative to the illuminating tubes 22.

2. Since the illuminating tubes 22 have sealed front and rear ends, they are not subject to invasion of dust and moisture and can therefore have prolonged usable life.

3. Since the illuminating tubes 22 are flexible, they have increased wear resistance.

What is claimed is:

1. An illuminating decoration for skateboard, comprising two illuminating tubes attached to two lateral sides of a skateboard, and electrically connected to a control box provided at an underside of said skateboard, such that said two illuminating tubes are turned on or off through control of said control box;
each of said two illuminating tubes including a transparent tube and a plurality of light-emitting elements disposed in said transparent tube; and
said illuminating tubes being sealed at front and rear ends thereof, such that said light-emitting elements are enclosed in said transparent tubes to emit light and produce even brightness without the risk of being invaded by dust and moisture.

2. The illuminating decoration for skateboard as claimed in claim 1, wherein said two illuminating tubes are sealed at front and rear ends by means of front and rear covers adapted to fitly mount on front and rear ends of said skateboard.

3. The illuminating decoration for skateboard as claimed in claim 1, wherein said transparent tubes forming said illuminating tubes are flexible and impact-resistant tubes.
